(19) United States
(12) Patent Application Publication
(10) Pub. No.: US 2026/0131677 A1
(43) Pub. Date: May 14, 2026

(54) VEHICLE

(71) Applicant: TOYOTA JIDOSHA KABUSHIKI KAISHA, Toyota-shi (JP)

(72) Inventors: Yuya AOKI, Miyoshi-shi (JP); Toru ANDO, Obu-shi (JP); Akitomo SHIRAI, Toyokawa-shi (JP)

(73) Assignee: TOYOTA JIDOSHA KABUSHIKI KAISHA, Toyota-shi (JP)

(21) Appl. No.: 19/348,141

(22) Filed: Oct. 2, 2025

(30) Foreign Application Priority Data
Nov. 12, 2024 (JP) 2024-197571

(51) Int. Cl. B60L 53/16

(52) U.S. Cl. CPC B60L 53/16

(57) ABSTRACT

When a charging connector is connected to an inlet, a charging control ECU puts a connector in a locked state by a lock device. When the lock device is in an unlocked state, the charging connector is removable from the inlet. The charging control ECU outputs an unlock command to the lock device when a vehicle speed is equal to or higher than a predetermined value and the lock device is in the locked state. When the lock device is not in the unlocked state after the unlock command is output, the charging control ECU diagnoses a failure of the lock device.

### CROSS-REFERENCE TO RELATED APPLICATION

This application claims priority to Japanese Patent Application No. 2024-197571 filed on November 12, 2024. The disclosure of the above-identified application, including the specification, drawings, and claims, is incorporated by reference herein in its entirety.

### BACKGROUND

### Technical Field

The present disclosure relates to a vehicle.

### Description of Related Art

Japanese Unexamined Patent Application Publication No. 2021-150980 (JP 2021-150980 A) discloses a vehicle charging device that determines a failure of a lock actuator for locking a power supply side connector (charging connector) connected to a charging port (inlet) of a vehicle. A control device for charging according to JP 2021-150980 A is configured to perform an operation check of the lock actuator when a vehicle speed is equal to or higher than a predetermined speed. In the operation check, an operation command to a lock pin is transmitted to the lock actuator, and the failure of the lock actuator is determined based on whether a position of the lock pin detected by a position detection sensor is at a position specified by the operation command.

### SUMMARY

In JP 2021-150980 A, while the charging connector is connected to the inlet, a temporary failure flag is turned on based on the position of the lock pin. When the temporary failure flag is on and the vehicle speed is equal to or higher than the predetermined vehicle speed, the lock actuator is operated a plurality of times to determine the failure of the lock actuator. Therefore, while the charging connector is connected to the inlet, the lock failure of the actuator cannot be determined unless the temporary failure flag is turned on.

An object of the present disclosure is to enable a diagnosis of a failure of a lock device even when there is no indication of the failure of the lock device while a charging connector is connected to an inlet.

A vehicle of the present disclosure includes an inlet to which a charging connector is connectable, a lock device configured to switch between a locked state in which the charging connector is not removable from the inlet and an unlocked state in which the charging connector is removable from the inlet, a detection device configured to detect the locked state and the unlocked state, and a control device. The lock device is configured to operate to the locked state upon receiving a lock command from the control device and operate to the unlocked state upon receiving an unlock command from the control device. The control device is configured to output the unlock command when the detection device detects the locked state while the vehicle is traveling, and diagnose a failure of the lock device when the detection device does not detect the unlocked state after the unlock command is output.

With the configuration, the lock device operates to the locked state upon receiving the lock command from the control device, and operates to the unlocked state upon receiving the unlock command from the control device. The control device outputs the unlock command when the detection device detects the locked state while the vehicle is traveling. The control device diagnoses the failure of the lock device when the detection device does not detect the unlocked state after the unlock command is output.

While the vehicle is traveling, the charging connector is removed from the inlet. In this state, when the locked state is detected and the unlock command is output, the lock device is switched from the locked state to the unlocked state, and the detection device detects the unlocked state. Even when the unlock command is received, the lock device is not switched to the unlocked state, and the unlocked state cannot be detected, a lock failure can be diagnosed. Therefore, the failure of the lock device can be diagnosed even when there is no indication of the failure while the charging connector is connected to the inlet.

The control device of the vehicle may be configured to output the unlock command when the detection device detects the locked state in a state where the charging connector is removed from the inlet, and diagnose the failure of the lock device when the detection device does not detect the unlocked state after the unlock command is output.

With the configuration, in a state where the charging connector is removed from the inlet, when the locked state is detected, the unlock command is output and the lock device is switched from the locked state to the unlocked state. Then, the detection device detects the unlocked state. Even when the unlock command is received, the lock device is not switched to the unlocked state, and the unlocked state cannot be detected, the lock failure can be diagnosed. Therefore, the failure of the lock device can be diagnosed even when there is no indication of the failure of the lock device while the charging connector is connected to the inlet.

The lock device may include a lock pin driven by an actuator, and the detection device may be configured to detect the locked state and the unlocked state based on a position of the lock pin.

With the configuration, the locked state and the unlocked state can be relatively easily detected by detecting the position of the lock pin.

The control device may be configured to issue an alert when the failure of the lock device is diagnosed.

With the configuration, the user can know that the failure of the lock device occurs.

According to the present disclosure, the failure of the lock device can be diagnosed even when there is no indication of the failure of the lock device while the charging connector is connected to the inlet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to the present embodiment;

FIG. 2 is a diagram illustrating an example of an appearance of a charging connector;

FIG. 3 is a diagram illustrating a schematic configuration of a lock device;

FIG. 4 is a flowchart showing an example of a failure detection process executed by a charging control ECU; and

FIG. 5 is a flowchart showing an example of the failure detection process executed by the charging control ECU in a modification.

### DETAILED DESCRIPTION OF EMBODIMENTS

An embodiment of the present disclosure will be described in detail with reference to the drawings. In the drawings, the same or similar parts are denoted by the same signs, and description thereof will not be repeated.

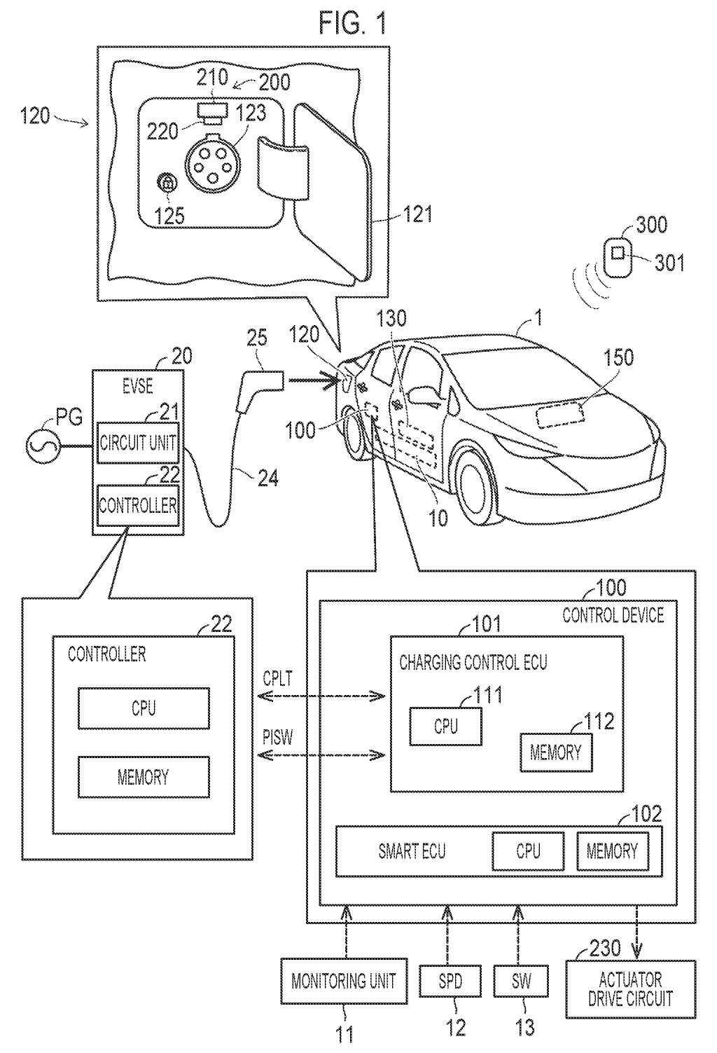

FIG. 1 is a diagram illustrating a schematic configuration of a vehicle 1 according to the present embodiment. The vehicle 1 includes a battery 10, a control device 100, an inlet 120, a charging circuit 130, and a human machine interface (HMI) device 150. The vehicle 1 is an electrified vehicle (xEV) configured to be able to travel using electric power stored in the battery 10. For example, a battery electric vehicle (BEV) may be used. The battery 10 is a known secondary battery for a vehicle, and may be, for example, a lithium ion battery.

The inlet 120 includes a charging lid 121 and a charging port 123. The charging lid 121 is configured to be opened and closed by a user, and in a closed state, cover the charging port 123, and in an open state, expose the charging port 123. When the battery 10 is charged, the charging connector 25 is connected to the charging port 123 in a state where the charging lid 121 is opened. The charging circuit 130 charges the battery 10 using electric power supplied from the outside of the vehicle to the charging port 123.

The control device 100 includes a charging control ECU 101 and a smart ECU 102. The charging control ECU 101 includes a central processing unit (CPU) 111 and a memory 112. The smart ECU 102 also includes a CPU and a memory in the same manner. The HMI device 150 includes an input unit and a display unit. The input unit and the display unit may be, for example, a touch panel display.

Electric vehicle supply equipment (EVSE) 20 charges the battery 10 with electric power supplied from an external power source PG (for example, an electric power system). The EVSE 20 includes a circuit unit 21 and a controller 22. The EVSE 20 further includes a charging cable 24 that extends from a main body of the EVSE 20 to the outside. The controller 22 includes a CPU and a memory, and controls the circuit unit 21. The circuit unit 21 includes, for example, a power conversion circuit and a circuit that charges the battery 10 with electric power supplied from the external power source PG. The charging connector (plug) 25 attachable to and detachable from the charging port 123 of the inlet 120 is provided at a tip of the charging cable 24. Charging from the EVSE 20 to the vehicle 1 (battery 10) is possible by connecting the charging connector 25 to the inlet 120 (charging port 123) of the vehicle 1.

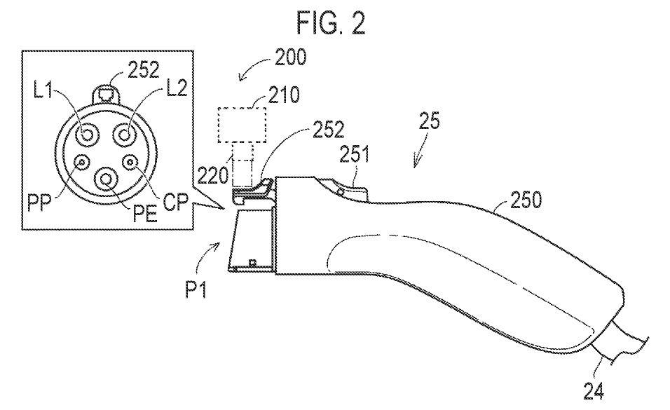

FIG. 2 is a diagram illustrating an example of an appearance of the charging connector 25. The charging connector 25 is provided with a connector terminal on an end surface P1 of a main body part 250, and the end surface P1 is connected to the charging port 123 of the inlet 120. The end surface P1 has the connector terminal. The connector terminal provided in the end surface P1 includes a terminal L1, a terminal L2, a terminal PE, a terminal PP, and a terminal CP. An inlet terminal is provided in the charging port 123 of the inlet 120, similar to the connector terminal provided on the end surface P1. The terminals L1, L2 are terminals to which electric power is supplied. For example, in a case of alternating current (AC) power, the terminals L1, L2 may be a hot terminal or a cold terminal. In a case of direct current (DC) power, the terminals L1, L2 may be a positive terminal or a negative terminal. The terminal PE is a ground (GND) terminal.

The terminal PP is a terminal (hereinafter, also referred to as “PISW”) for detecting (proximity detection) a state (connected state/mated state/unmated state) between the charging connector 25 and the inlet 120. Hereinafter, the state between the charging connector 25 and the inlet 120 is also referred to as a “connector state”. The terminal PP outputs a voltage signal (PISW signal) indicating the connector state to the vehicle 1 side. The terminal CP corresponds to a terminal (hereinafter, also referred to as “CPLT”) for a CPLT signal defined in, for example, a standard “IEC/TS 62763:2013”. The CPLT signal is a pulse width modulation (PWM) signal used for communication between the vehicle 1 and the EVSE 20.

The charging connector 25 further includes a latch release button 251 and a latch 252. The latch release button 251 releases a latch of the charging connector 25 to the inlet 120. The latch 252 is configured to engage with the inlet 120 to fix (latch) the charging connector 25 to the inlet 120. For example, the charging connector 25 is fixed by a tip of the latch 252 being hooked (engaged) in a recess provided in the inlet 120. The latch 252 is linked to the latch release button 251. When the user presses the latch release button 251, the engagement between the recess provided in the inlet 120 and the latch 252 is released (the fixing is released), and the charging connector 25 can be removed from the inlet 120.

The PISW signal indicates the connector state of the “connected state”, the “mated state”, and the “unmated state” based on a voltage of the PISW signal. The user inserts the charging connector 25 into the inlet 120 without pressing the latch release button 251, and mates the charging connector 25 and the inlet 120 (charging port 123). As a result, the charging connector 25 and the inlet 120 are fixed by the latch 252 in a state where the charging connector 25 and the inlet 120 are electrically connected. The connector state is the “connected state”. When the user presses the latch release button 251 in the connected state, the fixation by the latch 252 is released. The connector state is the “mated state”. When the user pulls the charging connector 25 from the inlet 120 in the mated state, the connector state becomes the “unmated state”. The unmated state is a state that is neither the connected state nor the mated state.

The inlet 120 is provided with a lock device 200 (see FIG. 1). The lock device 200 includes an actuator 210 and a lock pin 220. The actuator 210 is controlled by the charging control ECU 101 and the smart ECU 102 to advance and retreat the lock pin 220. The lock device 200 locks the charging connector 25 such that the charging connector 25 cannot be removed from the inlet 120 when the charging connector 25 is mated with the inlet 120. When the charging connector 25 is mated with the inlet 120 and the connector state is in the connected state, the lock pin 220 protrudes from a position indicated by a dashed line, as shown by a dash-dotted line in FIG. 2, and abuts the latch 252. A position where the lock pin 220 abuts the latch 252 is also referred to as a lock position. When the lock pin 220 abuts the latch 252, the latch 252 cannot move in a direction to disengage from the recess provided in the inlet 120. As a result, even when the latch release button 251 is pressed, the engagement between the recess provided in the inlet 120 and the latch 252 cannot be released, and a locked state in which the charging connector 25 cannot be removed from the inlet 120 is achieved.

The actuator 210 of the lock device 200 causes the lock pin 220 to return to the position indicated by the dashed line in FIG. 2. When the latch release button 251 is pressed by the user, the engagement between the recess provided in the inlet 120 and the latch 252 is released. As a result, the charging connector 25 can be removed from the inlet 120. The state is referred to as an unlocked state, and a position of the lock pin 220 in the unlocked state is also referred to as an unlock position. The unlocked state is a state in which the locked state is released.

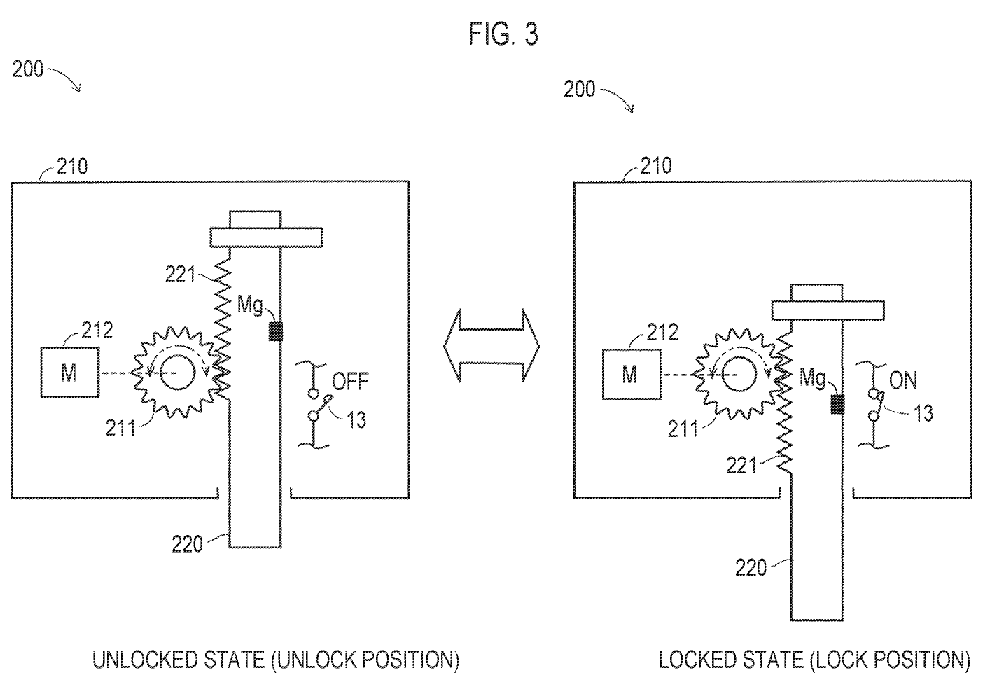

FIG. 3 is a diagram illustrating a schematic configuration of the lock device 200. Inside a housing of the actuator 210 of the lock device 200, a pinion gear 211 driven by a motor 212 and the lock pin 220 provided with a rack gear 221 that meshes with the pinion gear 211 are provided. When the lock device 200 is in the unlocked state (the lock pin 220 is in the unlock position), in a case where the pinion gear 211 is driven in a clockwise direction by the motor 212, the lock pin 220 advances and retreats to the lock position, and the locked state is achieved. When the lock device 200 is in the locked state (the lock pin 220 is in the lock position), in a case where the pinion gear 211 is driven in a counterclockwise direction by the motor 212, the lock pin 220 advances and retreats to the unlock position, and the unlocked state is achieved.

The lock device 200 is provided with a position sensor that detects the position of the lock pin 220. In the present embodiment, a limit switch 13 is provided that is OFF when the lock pin 220 is at the unlock position and is ON when the lock pin 220 is at the lock position. The limit switch 13 is a limit switch of a non-contact type, and the lock pin 220 is provided with a magnet Mg at a position facing the limit switch 13 when the lock pin 220 is at the lock position. As a result, when the lock pin 220 is at the lock position, the limit switch 13 is ON, and when the lock pin 220 is at the unlock position, the limit switch 13 is OFF. The limit switch 13 corresponds to an example of a “detection device” of the present disclosure.

With reference to FIG. 1, the control device 100 receives information of the battery 10 from a monitoring unit 11. For example, the monitoring unit 11 transmits a temperature TB, a voltage VB, input and output current IB, and the like of the battery 10. The monitoring unit 11 estimates state of charge (SOC) of the battery 10 and transmits the estimated SOC to the control device 100. The control device 100 receives a vehicle speed SPD from a vehicle speed sensor 12 and receives position information (lock position: ON signal, unlock position: OFF signal) of the lock pin 220 from the limit switch 13. The control device 100 outputs a lock command and an unlock command to an actuator drive circuit 230. When the actuator drive circuit 230 receives the lock command, the pinion gear 211 is driven in the clockwise direction by the motor 212, the lock pin 220 is moved to the lock position, and the unlock command is received. Then, the pinion gear 211 is driven in the counterclockwise direction, and the lock pin 220 is moved to the unlock position.

When the user inserts the charging connector 25 into the inlet 120 (charging port 123) while pressing the latch release button 251, the PISW signal is input to the control device 100 (charging control ECU 101) via the terminal PP of the charging connector 25. In addition, the CPLT signal is input to the charging control ECU 101 via the terminal CP. When the charging connector 25 and the inlet 120 are connected, the voltage of the PISW signal is decreased. When the charging control ECU 101 detects that the connector state is the connected state by the PISW signal, the charging control ECU 101 starts the communication with the EVSE 20 for charging preparation by the CPLT signal.

When the charging control ECU 101 detects the connected state of the connector state by the PISW signal, the charging control ECU 101 outputs the lock command to the actuator 210. When the actuator 210 receives the lock command from the charging control ECU 101, the actuator 210 drives the lock pin 220 to the lock position. Then, when the charging connector 25 and the inlet 120 are in the locked state and the charging preparation of the battery 10 is complete, a request is made to the EVSE 20 to start charging the battery 10, and the charging circuit 130 is controlled. During charging of the battery 10, the lock device 200 is in the locked state, and the charging connector 25 cannot be removed from the inlet 120.

In the present embodiment, the lock device 200 maintains the locked state until the user performs an unlock operation. The unlock operation by the user is performed by operating an unlock button 125 provided in the inlet 120. When the user presses the unlock button 125, the charging control ECU 101 outputs the unlock command. The actuator 210 drives the lock pin 220 to control the lock pin 220 to the unlock position upon receiving the unlock command.

The lock and unlock of the lock device 200 is also linked to an operation of the smart key 300. As a result, the user can perform the unlock operation using the smart key 300. The smart key 300 is a portable device carried by the user, and communicates with the smart ECU 102 to lock and unlock a door of the vehicle 1. For example, the vehicle 1 (smart ECU 102) transmits a polling signal in a low frequency (LF) band at a predetermined cycle. The smart key 300 that has received the polling signal transmits a response signal in a radio frequency (RF) band. The smart ECU 102 that has received the response signal executes an authentication process. The authentication is established, and the user performs a predetermined operation (for example, a touch operation of a touch sensor provided in a door knob of the vehicle 1). As a result, the smart ECU 102 unlocks the door and outputs the unlock command to the actuator 210. In this case, the unlock command may be transmitted to the actuator 210 via the charging control ECU 101. In addition, the door may be unlocked and the unlock command may be transmitted to the actuator 210 by operating an unlock switch 301 provided in the smart key 300. The actuator 210 drives the lock pin 220 to control the lock pin 220 to the unlock position upon receiving the unlock command.

When the lock device 200 is in the unlocked state and the charging connector 25 is removed from the inlet 120, the charging control ECU 101 detects that the connector state is the unmated state by the PISW signal. When the connector state is the unmated state, the charging control ECU 101 permits the vehicle 1 to travel. While the vehicle 1 is traveling, the lock pin 220 may be moved to the lock position due to vibration and the like. Even when the vehicle is not traveling, in a case where the connector state is the unmated state, the lock pin 220 is moved to the lock position for some reason and is in the locked state, the charging connector 25 cannot be connected to the inlet 120. In this case, the smart key 300 or the unlock button 125 is operated to set the lock device 200 to the unlocked state, and the charging connector 25 can be connected to the inlet 120. However, when the lock device 200 fails in the locked state, the locked state cannot be switched to the unlocked state, the charging connector 25 cannot be connected to the inlet 120, and the vehicle 1 cannot be charged. For the convenience of the user or repair, it is preferable to diagnose that the failure occurs in the lock device 200.

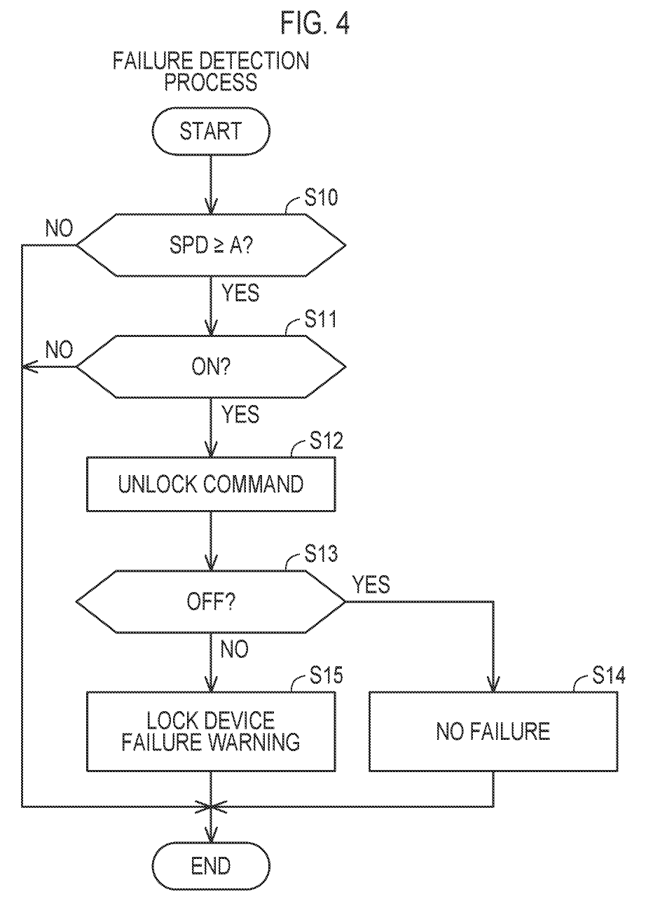

In the present embodiment, a diagnosis is made that the lock device 200 fails in the locked state, and the user is notified of the failure of the lock device 200. FIG. 4 is a flowchart showing an example of a failure detection process executed by the charging control ECU 101. The flowchart is repeatedly executed at predetermined periods when the charging control ECU 101 is activated. In step (hereinafter, step is abbreviated as “S”) 10, determination is made as to whether the vehicle speed SPD detected by the vehicle speed sensor 12 is equal to or higher than a predetermined value A. The predetermined value A may be a threshold value indicating that the vehicle 1 is traveling, and may be, for example, 5 km/h. When the vehicle speed SPD is less than the predetermined value A, the determination is negative, and the current routine is ended. When the vehicle speed SPD is equal to or higher than the predetermined value A, the determination is affirmative, and the process proceeds to S11.

In S11, determination is made as to whether the limit switch 13 is ON. When the position of the lock pin 220 is the lock position and the limit switch 13 is ON, the determination is affirmative, and the process proceeds to S12. When the lock pin 220 is at the unlock position and the limit switch 13 is OFF (not ON), the determination is negative, and the current routine is ended.

In S12, the charging control ECU 101 outputs the unlock command to the lock device 200 (actuator 210). The actuator 210 that has received the unlock command drives the lock pin 220 to the unlock position.

In S13 that follows, determination is made as to whether the limit switch 13 is OFF. When the lock pin 220 is at the unlock position and the limit switch 13 is OFF, the determination is affirmative, and the process proceeds to S14. When the position of the lock pin 220 is the lock position and the limit switch 13 is not OFF (is ON), the determination is negative, and the process proceeds to S15.

In S14, since the locked state is switched to the unlocked state by the unlock command in S12, the lock device 200 is diagnosed as not having failed, and the current routine is ended.

In S15, the lock device 200 is diagnosed as having failed, and the display unit of the HMI device 150 displays that the failure occurs in the lock device 200, and the current routine is ended. In S12, even though the unlock command is output, the locked state is not switched to the unlocked state, thus the lock device 200 can be diagnosed as having failed.

According to the present embodiment, the lock device 200 operates to the locked state upon receiving the lock command from the charging control ECU 101, and operates to the unlocked state upon receiving the unlock command. When the limit switch 13 detects the lock position (ON) while the vehicle 1 is traveling, the charging control ECU 101 outputs the unlock command. When the limit switch 13 does not detect the unlock position (OFF) after the output of the unlock command, the charging control ECU 101 diagnoses that the lock device 200 fails, displays the failure of the lock device 200 on the HMI device 150, and issues an alert. The diagnosis is made that the lock device 200 fails in the locked state, and the user can be notified of the failure of the lock device 200. The failure of the lock device 200 can be diagnosed even when there is no indication of the failure of the lock device 200 while the charging connector 25 is connected to the inlet 120.

### Modification

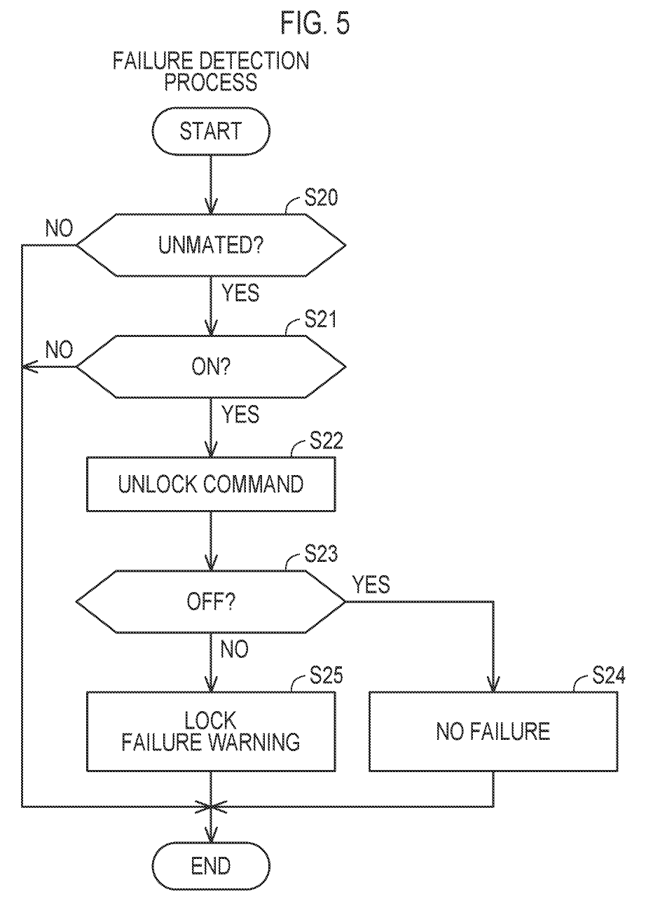

FIG. 5 is a flowchart showing an example of the failure detection process executed by the charging control ECU 101 in the modification. The flowchart is repeatedly executed at predetermined periods when the charging control ECU 101 is activated. In the modification, processes of S21 to S25 is the same as the process of S11 to S15 of the failure detection process of FIG. 4. In the modification, solely S20 is different from S10 of the failure detection process of FIG. 4.

In S20, the charging control ECU 101 determines as to whether the connector state is the unmated state based on the PISW signal. When the charging connector 25 is removed from the inlet 120 and the connector state is in the unmated state, the determination is affirmative, and the process proceeds to S21. When the connector state is the connected state or the mated state, the determination is negative, and the current routine is ended. The following processes are the same as the flowchart of FIG. 4, and thus the description thereof will be omitted.

Also in the modification, when the charging connector 25 is removed from the inlet 120 and the connector state is the unmated state, in a case where the limit switch 13 detects the lock position (ON), the charging control ECU 101 outputs the unlock command. When the limit switch 13 does not detect the unlock position (OFF) after the output of the unlock command, the charging control ECU 101 diagnoses that the lock device 200 fails, displays the failure of the lock device 200 on the HMI device 150, and issues the alert. The diagnosis is made that the lock device 200 fails in the locked state, and the user can be notified of the failure of the lock device 200. The failure of the lock device 200 can be diagnosed even when there is no indication of the failure of the lock device 200 while the charging connector 25 is connected to the inlet 120.

In the above-described embodiment, the charging control ECU 101 outputs the lock command to the actuator 210 and controls the actuator 210 to the locked state when the connection between the charging connector 25 and the inlet 120 is detected. However, the lock device 200 may be controlled to the locked state linked to a door lock operation by the smart key 300.

In the above-described embodiment, the lock device 200 is in the locked state in which the charging connector cannot be removed from the inlet 120 by the lock pin 220 abutting the latch 252. However, the lock mechanism of the lock device may have any configuration. For example, the lock pin of the lock device may be engaged with a recess provided in the charging connector to secure the locked state. In the above-described embodiment, the motor 212 and the rack and pinion mechanism drive the lock pin 220, but the actuator 210 may have any mechanism. For example, a configuration in which the lock pin is driven using an electromagnetic solenoid may be used.

In the above-described embodiment, the locked state and the unlocked state of the lock device 200 is detected by the limit switch 13 of the non-contact type. A limit switch of a contact type may be used to detect the locked state and the unlocked state. Further, the locked state and the unlocked state may be detected by the position sensor that detects the position of the lock pin 220, for example, a position sensor using a Hall element or an optical sensor.

The embodiment disclosed is to be considered merely illustrative and not restrictive in all respects. The scope of the disclosure is defined not by the detailed description of embodiments but by the claims, and is intended to cover all equivalents and all modifications within the scope of the claims.

What is claimed is:

1. A vehicle comprising:
an inlet to which a charging connector is connectable;
a lock device configured to switch between a locked state in which the charging connector is not removable from the inlet and an unlocked state in which the charging connector is removable from the inlet;
a detection device configured to detect the locked state and the unlocked state; and
a control device, wherein:
the lock device is configured to operate to the locked state upon receiving a lock command from the control device and operate to the unlocked state upon receiving an unlock command from the control device; and
the control device is configured to
output the unlock command when the detection device detects the locked state while the vehicle is traveling, and
diagnose a failure of the lock device when the detection device does not detect the unlocked state after the unlock command is output.

2. A vehicle comprising:
an inlet to which a charging connector is connectable;
a lock device configured to switch between a locked state in which the charging connector is not removable from the inlet and an unlocked state in which the charging connector is removable from the inlet;
a detection device configured to detect the locked state and the unlocked state; and
a control device, wherein:
the lock device is configured to operate to the locked state upon receiving a lock command from the control device and operate to the unlocked state upon receiving an unlock command from the control device; and
the control device is configured to
output the unlock command when the detection device detects the locked state in a state where the charging connector is removed from the inlet, and
diagnose a failure of the lock device when the detection device does not detect the unlocked state after the unlock command is output.

3. The vehicle according to claim 1 , wherein:
the lock device includes a lock pin driven by an actuator; and
the detection device is configured to detect the locked state and the unlocked state based on a position of the lock pin.

4. The vehicle according to claim 2, wherein:
the lock device includes a lock pin driven by an actuator; and
the detection device is configured to detect the locked state and the unlocked state based on a position of the lock pin.

5. The vehicle according to claim 1, wherein the control device is configured to issue an alert when the failure of the lock device is diagnosed.

6. The vehicle according to claim 2, wherein the control device is configured to issue an alert when the failure of the lock device is diagnosed.
